(19) United States
(12) Patent Application Publication
(10) Pub. No.: US 2019/0323858 A1
(43) Pub. Date: Oct. 24, 2019

(54) SYSTEMS AND METHODS FOR UTILITY USAGE NEGOTIATION BETWEEN FACILITIES

(71) Applicant: Walmart Apollo, LLC, Bentonville, AR (US)

(72) Inventors: Bruce W. Wilkinson, Rogers, AR (US); Charles Harry Lobo, Cave Springs, AR (US); Sid Shake, Rogers, AR (US)

(21) Appl. No.: 16/389,224

(22) Filed: Apr. 19, 2019

Related U.S. Application Data
(60) Provisional application No. 62/659,855, filed on Apr. 19, 2018.

(51) Int. Cl. G01D 4/00; H04L 12/28; G06Q 50/06; H04L 9/06; G06Q 20/14

(52) U.S. Cl. CPC G01D 4/004; H04L 12/2825; G06Q 40/04; H04L 9/0637; G06Q 20/145; G06Q 50/06

(57) ABSTRACT

Generally speaking, pursuant to various embodiments, systems, apparatuses, and methods are provided herein useful to controlling utility usage for a group of facilities. In some embodiments, a system comprises a plurality of devices located at a first facility, wherein the first facility is part of the group of facilities, and wherein each of the plurality of devices is configured to consume a utility, monitor its utility usage, and record, in a blockchain, an indication of its utility usage, wherein the blockchain ledger includes indications of utility usage for other facilities, and a control circuit configured to access the blockchain ledger, determine that the first facility has used more of the utility than an amount allotted, determine that a second facility has used less of the utility than an amount allotted, and negotiate, with the second facility, for allotment of a portion of the amount allotted to the second facility.

### CROSS-REFERENCE TO RELATED APPLICATION

This application claims the benefit of U.S. Provisional Application No. 62/659,855, filed Apr. 19, 2018, which is incorporated by reference in its entirety herein.

### TECHNICAL FIELD

This invention relates generally to monitoring utility usage and, more specifically, to controlling utility usage of a facility in a group of facilities.

### BACKGROUND

Utility usage can contribute significantly to operating costs of homes and businesses. Many homeowners and business owners budget for utility costs on a weekly, monthly, yearly, etc. basis. For example, a business may allocate a certain dollar amount or utility usage amount to each facility, a group of facilities, etc. Typically, this allocation is based on historical and/or predicted usage. Additionally, these allocations are typically specific to an entity (e.g., a facility, group of facilities, etc.). For example, Distribution Center A may be budgeted X kWh of electricity for a month and Warehouse A may be budgeted Y kWh of electricity for the month. Because allocations are made based on predictions and the allocations are specific to entities, there exists little flexibility to accommodate usage that varies from the allocation. Consequently, a need exists for improved systems, methods, and apparatuses for controlling utility usage.

### BRIEF DESCRIPTION OF THE DRAWINGS

Disclosed herein are embodiments of systems, apparatuses and methods pertaining to controlling utility usage for a group of facilities. This description includes drawings, wherein:

FIG. 1 depicts a system for controlling utility usage of a facility including a first facility 102, a blockchain ledger 108, and other facilities 110;

FIG. 2 is a block diagram of a system for controlling utility usage of a facility, according to some embodiments;

FIG. 3 is a flow chart depicting example operations for controlling utility usage of a facility, according to some embodiments;

FIG. 4 depicts an illustration of blocks, according to some embodiments;

FIG. 5 depicts an illustration of transactions, according to some embodiments;

FIG. 6 depicts a flow diagram, according to some embodiments;

FIG. 7 depicts a process diagram, according to some embodiments;

FIG. 8 depicts an illustration of a delivery record, according to some embodiments; and

FIG. 9 depicts a system diagram configured, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to controlling utility usage for a group of facilities. In some embodiments, a system comprises a plurality of devices located at a first facility, wherein the first facility is part of the group of facilities, wherein each of the plurality of devices is connected to a network, and wherein each of the plurality of devices is configured to consume a utility, wherein the utility is one or more of electricity, gas, water, and internet connectivity, monitor its utility usage, and record, in a blockchain ledger via the network, an indication of its utility usage, wherein the blockchain ledger includes indications of utility usage for other facilities in the group of facilities, and a control circuit associated with the first facility, wherein the control circuit is configured to access the blockchain ledger, determine, based on the blockchain ledger, that the first facility has used more of the utility than an amount allotted to the first facility, determine, based on the blockchain ledger, that a second facility has used less of the utility than an amount allotted to the second facility, and negotiate, with the second facility, for allotment of a portion of the amount allotted to the second facility to the first facility.

As previously discussed, many businesses and homeowners attempt to budget for utility costs. Often, these budgets are based on historical data and/or future predictions. From a business perspective, businesses often attempt to create budgets that factor in multiple facilities (e.g., some or all business facilities in geographic area). The budget attempts to allocate utility usage to each of the facilities so that the sum of the utility usage for all of the facilities included in the calculation does not exceed the allocation. For example, a business may include three facilities in a group of facilities (i.e., Facility₁, Facility₂, and Facility₃) and budget N kWh for electricity for the group of facilities for a month. Based on historical electricity usage for each of the facilities, the business may allocate X kWh to Facility₁, Y kWh to Facility₂, and Z kWh to Facility₃, where X+Y+Z=N (or X+Y+Z≤N). Embodiments of the systems, methods, and apparatuses described herein seek to track utility usage of facilities, such as Facility₁, Facility₂, and Facility₃, in a convenient decentralized manner. In some embodiments, this tracking can be performed in real time. Additionally, embodiments of the systems, methods, and apparatuses described herein seek to conveniently and easily allow for negotiation of allocation between the facilities during a time period for which the utility is budgeted. By tracking the utility usage and allowing for negotiation between facilities in a group of facilities, the systems, methods, and apparatuses described herein may be useful to controlling utility usage of a facility and/or a group of facilities.

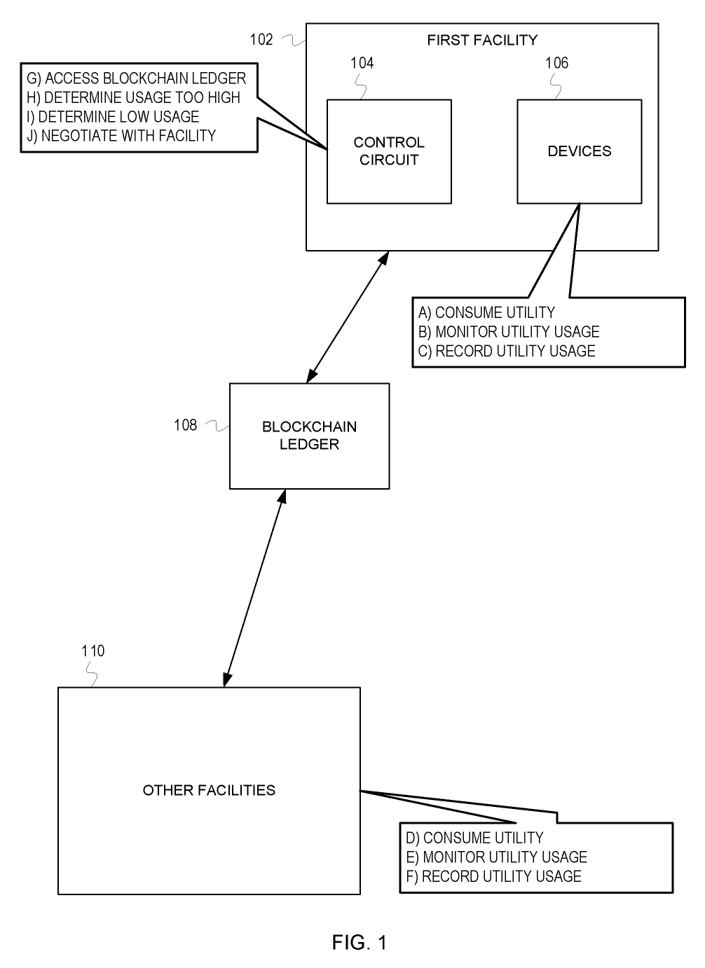

In some embodiments, devices within a facility include internet-of-things (IoT) capabilities (e.g., the devices are able to connect to, and communicate over, a network, such as the Internet or an intranet). In such embodiments, the devices can record their utility usage in accessible storage, such as a blockchain ledger. The system can access the blockchain ledger to determine utility usage for the facilities. If a first one of the facilities is above the amount allocated and a second one of the facilities is below the amount allocated, the system can perform a negotiation between the first and second facility. For example, the system could reallocate a portion of the second facility's usage to the first facility. With respect to the example above, if Facility₁ has already used its allotted X kWh and Facility₂ has not yet used its allotted Y kWh and there are three days remaining in the month, the system can allocate a portion of Facility₂'s Y kWh to Facility₁ with the goal being that the total utility usage will remain at or below N kWh. The discussion of FIG. 1 provides and overview of such a system.

FIG. 1 depicts a system for controlling utility usage of a facility including a first facility 102, a blockchain ledger 108, and other facilities 110. The example operations depicted in FIG. 1 include operations between the first facility 102 and the other facilities 110. FIG. 1 depicts operations at stages A-J. The stages are examples and are not necessarily discrete occurrences over time (e.g., the operations of different stages may overlap). Additionally, FIG. 1 is an overview of example operations.

At stage A, one or more utilities are consumed by devices 106 located in (i.e., associated with) the first facility 102. The devices 106 can be any type of device that consumes a utility, such as light fixtures, generators, furnaces, appliances, water heaters, computers, networking equipment, robots, vehicles, etc. The utility can be any type of service provided to the first facility, such as electricity, gas, water, fuel, resources, internet connectivity, etc. Each of the devices 106 can consume a single utility or multiple utilities. For example, a computer may consume both electricity and internet connectivity. Additionally, the first facility 102 is part of a group of facilities. For example, the group of facilities may include the first facility 102 and the other facilities 110. The facilities that comprise the group of facilities can be owned or operated by a single entity or multiple entities.

At stage B, the devices 106 monitor their utility usage. That is, as the devices 106 operate and consume a utility, each device monitors its consumption. Some of the devices 106 may be capable of monitoring their utility usage without any special equipment. For example, a “smart” device may have a metering mechanism built in. Others of the devices 106 may be required to be retrofitted with a metering mechanism. Still other devices may communicate with external sensors coupled with the device. The external sensor may track utility usage and communicate that usage information to the device or a separate device, such as directly to the control circuit 104 or other device that can track and/or update the blockchain ledger. Alternatively, or additionally, the sensor may be configured to communicatively couple with the network and itself update the blockchain ledger corresponding to the utility usage by the device(s) with which the external sensor is associated.

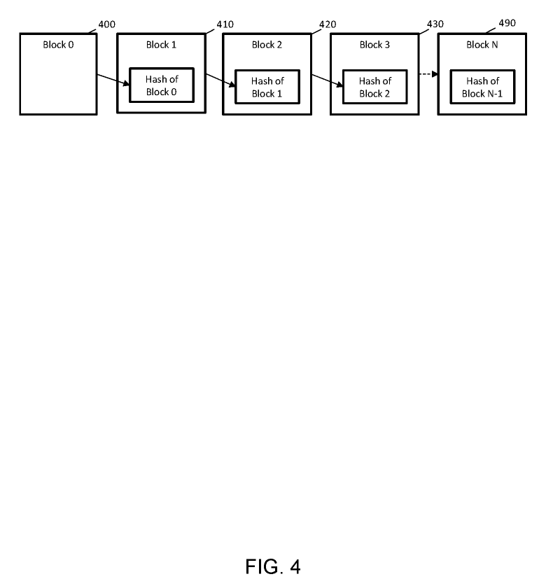

At stage C, the devices 106 record their utility usage (i.e., the devices 106 record indications of their utility usage). The devices 106 record indications of their utility usage to an accessible storage location. For example, the storage location can be accessible by the other facilities 110. In some embodiments, the devices 106 record indications of their utility usage to a blockchain ledger 108. The blockchain ledger 108 provides for decentralized storage of the utility usage data. Due the decentralized manner of the utility usage data, any device with access to the blockchain ledger 108 can access the utility usage data. Consequently, the facilities do not need to communicate directly with one another to obtain this data. Additional information regarding blockchain ledgers is provided in the discussion of FIGS. 4-9.

At stages D-F, devices located in (i.e., associated with) the other facilities 110 consume utilities, monitor utility usage, and record utility usage in the blockchain ledger 108. These operations are similar to those described with respect to stages A-C above. By aggregating utility usage data in the blockchain ledger 108, any device with access to the blockchain ledger 108 can access the utility usage data for devices across a number of facilities. In some embodiments, the devices in each facility that is associated with the group of facilities perform these operations.

At stage G, a control circuit 104 accesses the blockchain ledger 108. In some embodiments, the control circuit 104 is located at the first facility 102 (i.e., the control circuit 104 is associated with the first facility). In other embodiments, the control circuit 104 can be associated with multiple facilities (e.g., the first facility 102 and some or all of the other facilities 110). In either case, the control circuit 104 can access utility usage data stored in the blockchain ledger 108 by accessing the blockchain ledger 108.

At stage H, the control circuit 104 determines that the utility usage for the first facility 102 is too high. That is, the control circuit 104 determines, based on the indications of the utility usage in the blockchain ledger 108, that the devices 106 in the first facility have consumed a greater amount of a utility than allotted to the first facility 102 or has exceed one or more allotted thresholds. In some embodiments, the facilities are allotted a certain amount of a utility. For example, the first facility 102 may be allotted 500 kWh of electricity. For example, a furnace, possibly in conjunction with other devices, associated with the first facility 102 may have used more natural gas than allotted to the first facility 102, or the vehicles associated with the first facility 102 may have used more fuel than allotted to the first facility 102. In some embodiments, the control circuit 104 makes this determination by referencing a database. The database can include the allocations for different utilities for the first facility 102 and, in some embodiments, the allocations for different utilities for the other facilities 110. Additionally, in some embodiments, the database can include allotments for one or more of the devices 106. In some embodiments, this database, or data similar to what would be included in this database, can be stored in the blockchain ledger 108 for the decentralized and easy access by multiple if not all of the associated facilities.

At stage I, the control circuit 104 determines that a second facility (i.e., one of the other facilities 110) has used less of a utility than was allotted to the second facility. That is, the control circuit 104 determines, based on indications of utility usage in the blockchain ledger 108, that the devices in the second facility have consumed a lesser amount of a utility than allotted to the second facility. Following the example provided above, a furnace, possibly in conjunction with other devices, associated with the first facility 102 may have used less natural gas than allotted to the second facility, or the vehicles associated with the second facility may have used more fuel than allotted to the second facility.

At stage J, the control circuit 104 negotiates with the second facility. For example, the control circuit 104 can negotiate with a control circuit associated with the second facility. The negotiation between the control circuit 104 and the second facility is for reallocation of a portion of the utility allocated to the second facility. That is, because the second utility has used less of a utility than allotted to the second facility and the first facility 102 has used more of a utility than allocated to the first facility 102, the control circuit negotiates with the second facility in an attempt to increase the first facility's allocation of the utility to, at least partially, cover the first facility's excess usage of the utility. In some embodiments, this negotiation can occur proactively. For example, the control circuit 104 can begin a negotiation before the utility usage for the first facility 102 is above the allocation. That is, that the “first facility 102 has used more of the utility than an amount allotted to the first facility 102” can occur before the utility usage of the first facility 102 is above the allocation. For example, if the control circuit 104 determines that based on the historical utility usage for the time period (e.g., a day, week, month, year, etc.) that it is predicted that the utility usage of the first facility will be above the allotment, the control circuit 104 can determine that the utility usage for the first facility 102 is too high. In some embodiments, the prediction can be based on past usage, estimated increased volume (e.g., in conjunction with an even near one of the facilities), weather forecasts, etc. In such embodiments, the control circuit 104 can begin the negotiation process at this point (i.e., before the utility usage for the first facility 102 has exceeded the allotment). Additionally, in some embodiments, the control circuit 104 can negotiate with multiple ones of the other facilities 110. For example, the control circuit 104 can negotiate with the second facility, as well as a third facility, for electricity. Further, in some embodiments, the control circuit 104 can negotiate with a single (or multiple) facilities for multiple utilities. For example, the control circuit 104 can negotiate with the second facility for electricity, the third facility for electricity and internet connectivity, and a fourth facility for water and gas. In any event, the negotiations performed by the control circuit can include payments (i.e., payment for a portion of another facilities utility allotment), trades (e.g., the first facility 102 can trade its surplus electricity for the second facilities surplus gas), or no value at all (i.e., the negotiation is done without the exchange of value but is recorded).

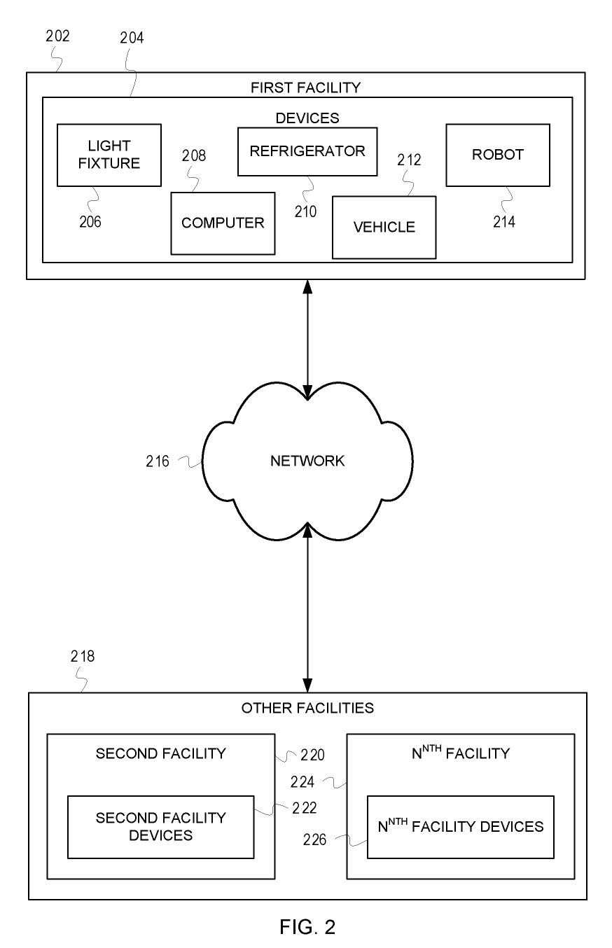

While the discussion of FIG. 1 provides an overview of a system for controlling utility usage for a facility, the discussion of FIG. 2 provides additional details regarding such a system.

FIG. 2 is a block diagram of a system for controlling utility usage of a facility, according to some embodiments. The system includes a first facility 202, a network 216, and other facilities 218. The first facility 202 can be any type of business or residential facility, such as a distribution center, an office, a store, a warehouse, a data center, a server farm, a filling station, a home, an apartment, etc. The first facility 202 includes a number of device 204. Each of the devices 204 is associated with the first facility 202 (i.e., the devices 204 are “located at” the first facility 202). The devices 204 can be any suitable device that consumes a utility. FIG. 2 depicts a light fixture 206, a computer 208, a refrigerator 210, a vehicle 212, and a robot 214 as examples of the devices 204 that are associated with the first facility 202. Each of the devices 204 consumes one or more utilities. For example, the light fixture 206 may consume electricity, the computer 208 may consume electricity and internet connectivity, the refrigerator 210 may consume electricity and water, the vehicle 212 may consume fuel, electricity, and/or internet connectivity, and the robot 214 may consume electricity, water, resources (e.g., steel, aluminum, plastic, etc.), gas, and/or internet connectivity.

Like the first facility 202, the other facilities can include any type of business or residential facilities. The other facilities 218 can include any number of facilities, as indicated by a second facility 220 and an N^{th} facility 224 depicted in FIG. 2. Each of the other facilities 218 include devices. As depicted in FIG. 2, the second facility 220 includes second facility devices 222 and the N^{th} facility 224 includes N^{th} facility devices 226. The other facilities 218 can be remote and/or local to the first facility 202. That is, the other facilities 218 can be in the same geographic region and/or different geographic regions than the first facility 202.

As the devices 204, second facility devices 222, and N^{th} facility devices 226 consume the utilities, the devices 204, second facility devices 222, and N^{th} facility devices 226 record indications of their utility usage. For example, the devices 204, second facility devices 222, and N^{th} facility devices 226 can record the indications of their utility usage in a blockchain ledger. In some embodiments, the devices 204, second facility devices 222, and N^{th} facility devices 226 record the indications of utility usage in the blockchain ledger via the network 216. The network 216 can be of any suitable type (e.g., the network 216 can be the Internet and/or local networks connected to the Internet). As the devices 204, second facility devices 222, and N^{th} facility devices 226 record indications of utility usage to the blockchain ledger, a control circuit monitors the utility usage. The control circuit can be associated with a single facility (e.g., the first facility 202) or be associated with a number of facilities. The control circuit monitors the utility usage via the blockchain ledger.

Based on the monitoring of the utility usage, the control circuit can perform negotiations between the facilities. For example, if the second facility 220 has used more gas than allotted to the second facility 220 and the first facility 202 has used less gas than allotted to the first facility 202, the control circuit can perform a negotiation between the second facility 220 and the first facility 202 to reallocate a portion of the first facility's 202 gas allocation to the second facility 220. In some embodiments, this negotiation can include the exchange of value. For example, the second facility 220 can purchase the portion of the first facility's 202 gas allocation for a set amount per unit. Alternatively, the price (i.e., the set mount per unit) can also be negotiated. Additionally, or alternatively, the negotiation can involve a trade for example, of utility allocations. The parameters involved in the negotiation can include any suitable aspects, such as predicted utility usage for either or both of the first facility 202 and the second facility 220, whether the first facility 202 has exceeded the allotment and/or how soon the first facility 202 will exceed the allotment, whether the second facility 220 is predicted to exceed its allotment, etc.

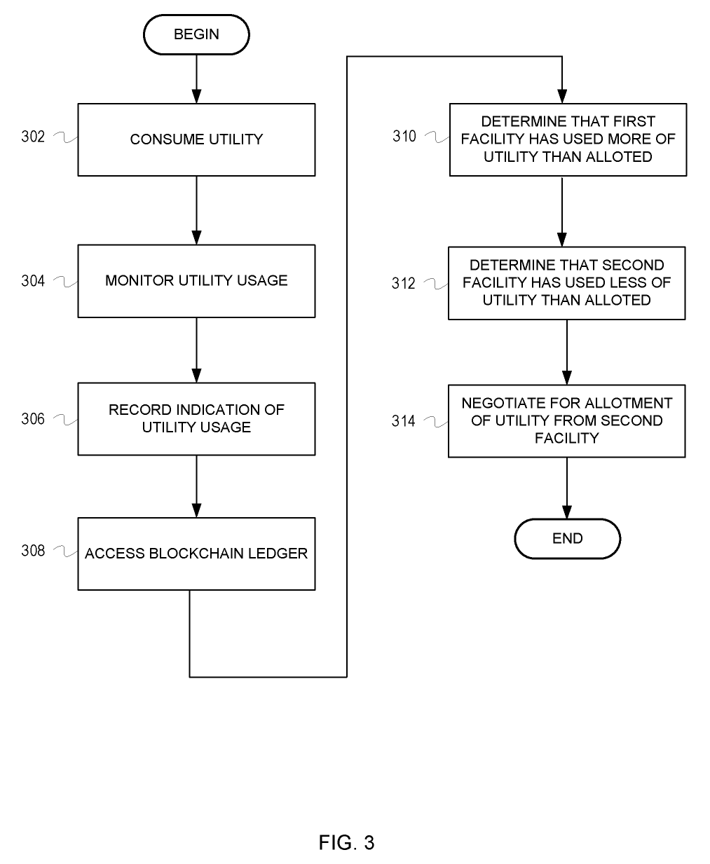

While the discussion of FIGS. 1-2 provide information about a system for controlling utility usage for a facility, the discussion of FIG. 3 describes example operations of such a system.

FIG. 3 is a flow chart depicting example operations for controlling utility usage of a facility, according to some embodiments. The flow begins at block 302.

At block 302, utilities are consumed. For example, devices associated with facilities consume the utilities. The devices can be any type of device that consumes one or more utilities. For example, the devices can be appliances, machines, computers, vehicles, etc. The devices are located in facilities (i.e., associated with facilities). For example, a facility could include a number of devices such as cars or trucks, computers, light fixtures, furnaces, etc. The flow continues at block 304.

At block 304, utility usage is monitored. For example, the devices can monitor their utility usage. In some embodiments, the devices are capable of monitoring their utility usage without modification. For example, a vehicle may come equipped with a metering mechanism capable of monitoring fuel consumption. Additionally, or alternatively, some of the devices may need to be equipped with a metering mechanism to monitor their utility usage. For example, a dishwasher may need to be equipped with special hardware and/or software to monitor its electrical and water usage. The flow continues at block 306.

At block 306, indications of utility usage are recorded. For example, the devices can record indications of their utility usage. Preferably, the devices record indications of their utility usage in an accessible location (e.g., cloud storage). In some embodiments, the devices record indications of their utility usage in a blockchain ledger so as to create a secure and substantially immutable record. Additionally, the blockchain ledger provides a decentralized processing and storage of the usage information, which further provides redundancy and allows access to the blockchain ledger by numerous different control circuits and other systems. The flow continues at block 308.

At block 308, the blockchain ledger is accessed. For example, a control circuit can access the blockchain ledger. The control circuit accesses the blockchain ledger to view the indications of the utility usage. The control circuit can be specific to a facility, or common to a number of facilities. In either case, by accessing the blockchain ledger, the control circuit can view utility usage of all devices and/or facilities that report usage to the blockchain ledger. The flow continues at block 310.

At block 310, it is determined that a first facility has used more of a utility than allotted to the first facility. For example, the control circuit can determine that the first facility has used more of the utility than allotted to the first facility. That is, based on the control circuit accessing the blockchain ledger, the control circuit can determine that the first facility has used more of the utility than allotted to the first utility. The allotment can be based on historical and/or predictive planning. The flow continues at block 312.

At block 312, it is determined that a second facility has used less of the utility than allotted to the second facility. For example, the control circuit can determine that the second facility has used less of the utility than allotted to the second facility. That is, based on the control circuit accessing the blockchain ledger, the control circuit can determine that the second facility has used less of the utility than allotted to the second utility. The flow continues at block 314.

At block 314, allotment of a portion of the amount allocated of the utility to the second facility to the first facility is negotiated. For example, the control circuit can negotiate with the second facility for a portion of the amount of the utility allotted to the second facility be allotted to the first facility. This negotiation can be performed in an attempt to control the utility usage of the first facility and/or the group of facilities.

While the discussion of FIGS. 1-3 describes a system for controlling utility usage of a facility, descriptions of some embodiments of blockchain technology are provided with reference to FIG. 4-9 herein. In some embodiments described above, blockchain technology may be utilized to record utility usage by devices of facilities. One or more of the servers and devices described herein may comprise a node in a distributed blockchain system storing a copy of the blockchain record (i.e., a blockchain ledger). Updates to the blockchain may comprise addition of blocks containing indications of utility usage and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 200200 represents a genesis block of the chain. Block 1 410 contains a hash of block 0 400, block 2 420 contains a hash of block 1 410, block 3 430 contains a hash of block 2 420, and so forth. Continuing down the chain, block N 490 contains a hash of block N-1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

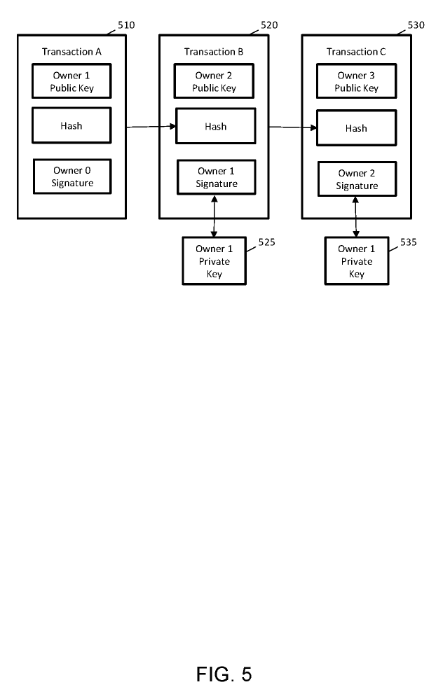

Now referring to FIG. 5, an illustration of blockchain-based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner l's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 520. In some embodiments, when each transaction record is created, the system may check previous transaction records and the current owner's private and public key signature to determine whether the transaction is valid. In some embodiments, transactions are being broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

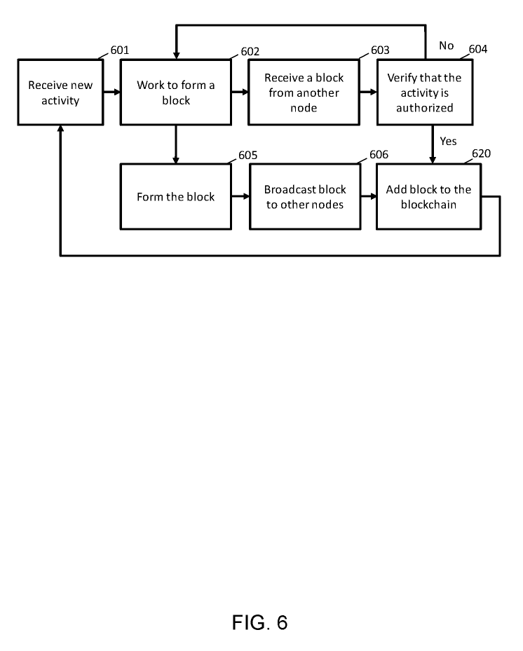

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise a asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these blocks if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

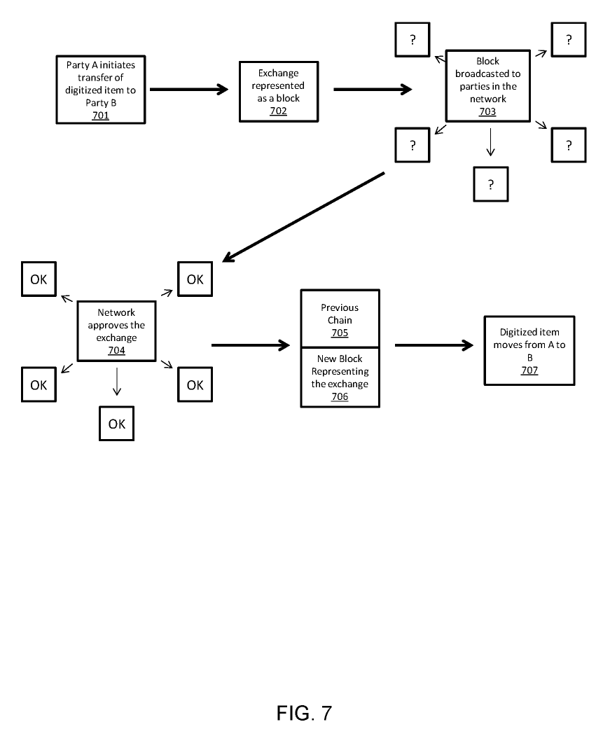

Now referring to FIG. 7, a process diagram a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

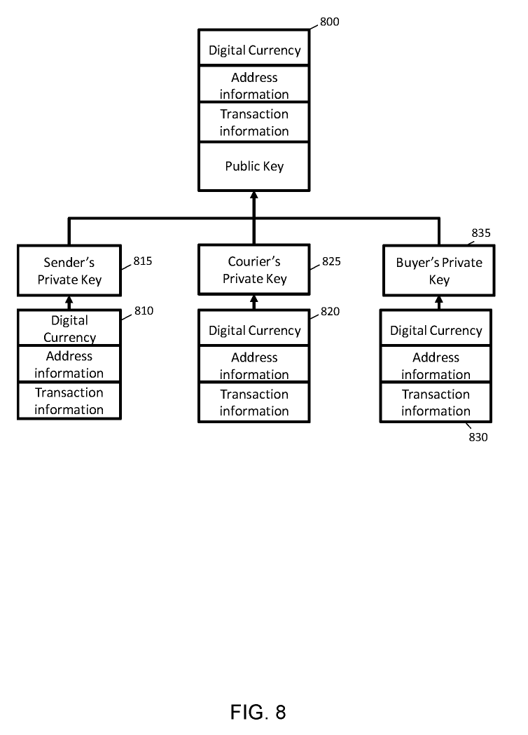

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

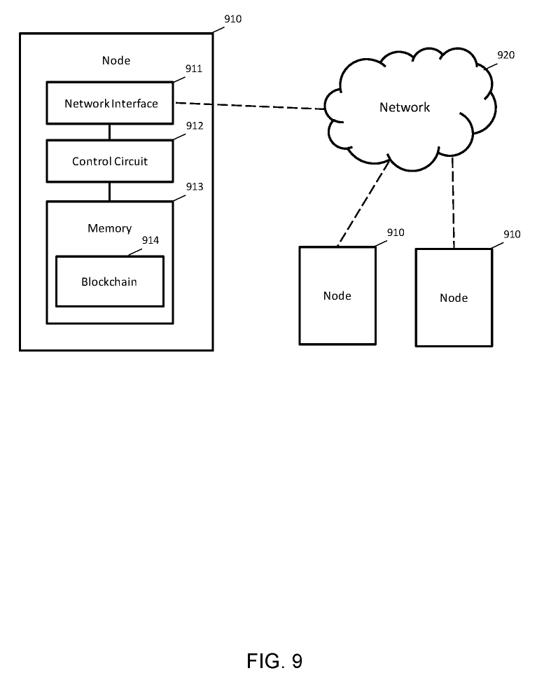

Now referring to FIG. 9, a system according to some embodiments is shown. A distributed blockchain system comprises a plurality of nodes 910 communicating over a network 920. In some embodiments, the nodes 910 may be comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 8-9 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In some embodiments, a system comprises a plurality of devices located at a first facility, wherein the first facility is part of the group of facilities, wherein each of the plurality of devices is connected to a network, and wherein each of the plurality of devices is configured to consume a utility, wherein the utility is one or more of electricity, gas, water, and internet connectivity, monitor its utility usage, and record, in a blockchain ledger via the network, an indication of its utility usage, wherein the blockchain ledger includes indications of utility usage for other facilities in the group of facilities, and a control circuit associated with the first facility, wherein the control circuit is configured to access the blockchain ledger, determine, based on the blockchain ledger, that the first facility has used more of the utility than an amount allotted to the first facility, determine, based on the blockchain ledger, that a second facility has used less of the utility than an amount allotted to the second facility, and negotiate, with the second facility, for allotment of a portion of the amount allotted to the second facility to the first facility.

In some embodiments, an apparatus and a corresponding method performed by the apparatus comprises consuming, by a plurality of devices, a utility, wherein the utility is one or more of electricity, gas, water, and internet connectivity, wherein the plurality of devices is located at a first facility, wherein the first facility is part of the group of facilities, and wherein each of the plurality of devices is connected to a network, monitoring, by the plurality of devices, utility usage of each of the plurality of devices, recording, by each of the plurality of devices in a blockchain ledger via the network, an indication of the utility usage of each of the plurality of devices, wherein the blockchain ledger includes indications of utility usage for other facilities in the group of facilities, accessing, by a control circuit, the blockchain ledger, determining, based on the blockchain ledger, that the first facility has used more of the utility than an amount allotted to the first facility, determining, based on the blockchain ledger, that a second facility has used less of the utility than an amount allotted to the second facility, and negotiating, by the control circuit with the second facility, for allotment of a portion of the amount allotted to the second facility for the first facility.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for controlling utility usage for a group of facilities, the system comprising:
a plurality of devices located at a first facility, wherein the first facility is part of the group of facilities, wherein each of the plurality of devices is connected to a network, and wherein each of the plurality of devices is configured to:
consume a utility, wherein the utility is one or more of electricity, gas, water, fuel, resources, and internet connectivity;
monitor its utility usage; and
record, in a blockchain ledger via the network, an indication of its utility usage, wherein the blockchain ledger includes indications of utility usage for other facilities in the group of facilities; and
a control circuit associated with the first facility, wherein control circuit is configured to:
access the blockchain ledger;
determine, based on the blockchain ledger, that the first facility has used more of the utility than an amount allotted to the first facility;
determine, based on the blockchain ledger, that a second facility has used less of the utility than an amount allotted to the second facility; and
negotiate, with the second facility, for allotment of a portion of the amount allotted to the second facility for the first facility.

2. The system of claim 1, wherein the plurality of devices includes internet-of-things (IoT) devices.

3. The system of claim 2, wherein the IoT devices include one or more of a memory, transceiver, and processor.

4. The system of claim 1, wherein the group of facilities includes one or more of retail facilities, warehouses, distribution centers, office facilities, and manufacturing facilities.

5. The system of claim 1, wherein the first facility and second facility are in different geographic regions.

6. The system of claim 1, wherein the first facility and the second facility are in a same geographic region.

7. The system of claim 1, wherein the plurality of devices includes one or more of light fixtures, generators, furnaces, appliances, water heaters, computers, networking equipment, robots, and vehicles.

8. The system of claim 1, wherein the negotiation performed by the control circuit includes payment.

9. The system of claim 1, wherein the negotiation performed by the control circuit includes an exchange of a second utility for the portion of the amount allotted to the second facility.

10. A method for controlling utility usage for a group of facilities, the method comprising:
consuming, by a plurality of devices, a utility, wherein the utility is one or more of electricity, gas, water, fuel, resources, and internet connectivity, wherein the plurality of devices is located at a first facility, wherein the first facility is part of the group of facilities, and wherein each of the plurality of devices is connected to a network;
monitoring, by the plurality of devices, utility usage of each of the plurality of devices;
recording, by each of the plurality of devices in a blockchain ledger via the network, an indication of the utility usage of each of the plurality of devices, wherein the blockchain ledger includes indications of utility usage for other facilities in the group of facilities;
accessing, by a control circuit, the blockchain ledger;
determining, based on the blockchain ledger, that the first facility has used more of the utility than an amount allotted to the first facility;
determining, based on the blockchain ledger, that a second facility has used less of the utility than amount allotted to the second facility; and
negotiating, by the control circuit with the second facility, for allotment of a portion of the amount allotted to the second facility for the first facility.

11. The method of claim 10, wherein the plurality of devices includes internet-of-things (IoT) devices.

12. The method of claim 11, wherein the IoT devices include one or more of a memory, transceiver, and processor.

13. The method of claim 10, wherein the group of facilities includes one or more of retail facilities, warehouses, distribution centers, office facilities, and manufacturing facilities.

14. The method of claim 10, wherein the first facility and the second facility are in different geographic regions.

15. The method of claim 10, wherein the first facility and the second facility are in a same geographic region.

16. The method of claim 10, wherein the plurality of devices includes one or more of light fixtures, generators, furnaces, appliances, water heaters, computers, networking equipment, robots, and vehicles.

17. The method of claim 10, wherein the negotiating includes payment.

18. The method of claim 10, wherein the negotiating includes an exchange of a second utility for the portion of the amount allotted to the second facility.
